(19) United States
(12) Patent Application Publication
(10) Pub. No.: US 2007/0027940 A1
(43) Pub. Date: Feb. 1, 2007

(54) Defragmenting one or more files based on an indicator

(76) Inventors: Bruce A. Lutz, Pepperell, MA (US); Robert A. Breau, Hudson, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/189,537

(22) Filed: Jul. 26, 2005

(51) Int. Cl. G06F 17/30

(52) U.S. Cl. 707/205

(57) ABSTRACT

A system comprises software, a storage subsystem to store files, a file system to organize and manage access to files, and a data structure to store at least one indicator of whether at least one of the files is fragmented. A defragment module defragments the at least one of the files based on the at least one indicator while the file system remains available to the software.

### BACKGROUND

Data can be stored in various types of storage devices, including magnetic storage devices (such as magnetic disk drives), optical storage devices, integrated circuit storage devices, and so forth. Typically, in computers, data is stored in files that are managed by a file system. A file system is a mechanism for storing and organizing data to allow software in a computer to easily find and access the data.

Files associated with a file system can become fragmented as the files grow in size. A fragmented file is a file that does not reside in a contiguous region of a storage medium, but rather is stored as multiple fragments in respective dis-contiguous regions of the storage medium. Fragmented files decrease performance of a storage system, since the storage system has to expend resources and seek time to find fragments of a file, which can be located quite far apart on a storage medium of the storage system. As the number of fragmented files grows, storage system performance is decreased, which results in longer wait times experienced by users or software applications when accessing files in the storage system.

Conventionally, defragment utilities have been provided to defragment files in a file system. Typically, with many defragment utilities, a file system has to be first taken offline (such as by unmounting the file system), which renders the file system unavailable for access. For a large file system, the amount of time spent by the defragment utility to defragment files of the file system can be relatively long. Due to the relatively long execution time of a defragment operation, a defragment utility may not be frequently run, which may result in file system performance degradation during relatively long time periods between defragment operations.

### BRIEF DESCRIPTION OF THE DRAWINGS

FIG. 1 is a block diagram of an example system that incorporates a defragment mechanism according to an embodiment.

FIG. 2 is a flow diagram of an example process for setting fragment indicators by the defragment mechanism, according to an embodiment.

FIG. 3 is a flow diagram of an example process of finding a cluster with a fragmented file and sending a message to a message queue regarding the fragmented file, according to an embodiment.

FIG. 4 is a flow diagram of an example process of invoking defragmentation based on the fragment indicators, according to an embodiment.

### DETAILED DESCRIPTION

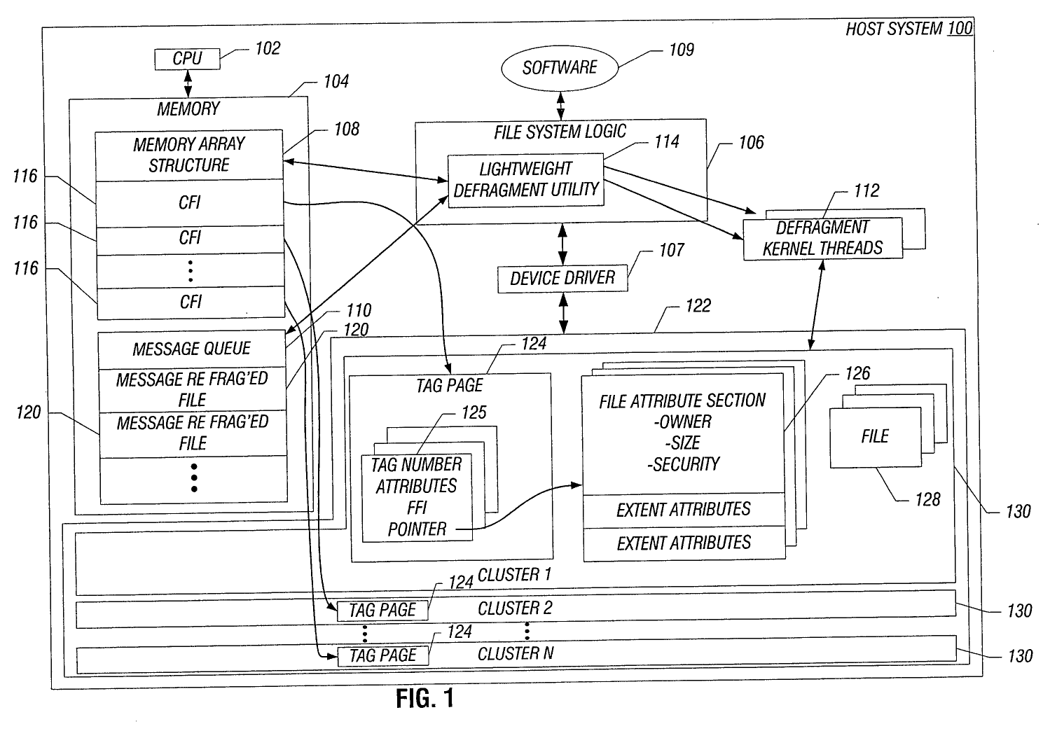

FIG. 1 depicts a host systems 100 that includes a storage subsystem 122, where the storage subsystem 122 includes a storage medium for storing various types of data, including files 128, file attribute sections 126 associated with respective files 128, and tag pages 124 (that contain file fragment indicators (FFIs) according to some embodiments). The term “storage medium” refers to either a single storage medium or multiple storage media (e.g., multiple disks, multiple chips, etc.).

The files 128 contain “user data,” which broadly refers to data that is associated with a user, application, or other software in a computer system. Examples of user data include, but are not limited to, user files, software code, and data maintained by applications or other software. The file attribute sections 126 that correspond to respective files 128 are part of file system metadata associated with the files 128. File system metadata includes information that relates to the structure, content, and attributes of files containing user data.

As depicted in FIG. 1, each example file attribute section 126 contains information relating to the owner of a file, the size of a file, security information of the file, and other metadata. In the example implementation depicted in FIG. 1, the file attribute section 126 also contains extent attributes. An “extent” refers to one or more adjacent blocks of data within a file system. A “block” of data refers to some predefined collection of data of a given size. Extent attributes are attributes associated with an extent, where the extent attributes of an extent indicate the starting block address and the length of the extent. In an extent-based file system, a file is stored in a group of one or more extents. However, note that in other implementations, files can be stored according to other types of allocations, such as block-based allocations or other allocations. In implementations that are not extent-based, the file attribute sections 126 do not contain extent attributes.

In accordance with some embodiments, the storage subsystem 122 also stores tag pages 124, where each tag page 124 includes multiple entries 125 that correspond to respective files 128. The entries 125 are also referred to as “tag files.” Each tag page entry 125 (or tag file) is basically an index to the corresponding file attribute section 126 that contains detailed metadata for the respective user data file (128). Each entry 125 of the tag page 124 includes the following information: a tag number (also referred to as a file identifier) for identifying the respective file; a pointer to a respective file attribute section 126; and a file fragment indicator (FFI) that provides an indication of whether the respective file is fragmented or not fragmented.

The pointer in each tag page entry 125 is an address that identifies a location of the corresponding file attribute section 126. Note that there is a one-to-one correspondence between a tag page entry 125 and a file attribute section 126, according to one example implementation.

The file fragment indicator is a field that has a first value (also referred to as a “set state”) to indicate that the corresponding file is fragmented, and a second value (also referred to as a “cleared state”) to indicate that the corresponding file is not fragmented. In some implementations, the tag page entry 125 can also include a small set or minimal set of some of the attributes contained in the file attribute section 126. Each piece of information in the tag page entry 125 can be considered an “attribute.”

Although the file fragment indicators are depicted as being stored in tag pages 124 in accordance with an embodiment, the file fragment indicators can be stored in the file attribute sections 126 in other embodiments.

If a file 128 is stored in a single extent, then that file is stored in contiguous blocks of the storage medium of the storage subsystem 122. The storage of a file in a single extent is an indication that the file is not fragmented. However, if a file is stored in multiple extents, then multiple sets of extent attributes will be stored in the file attribute section 126 for the file. Storage of a file in multiple extents is an indication that the file is fragmented. Thus, according to one embodiment, the file fragment indicator has a value that is based on the number of extents associated with the corresponding file. If the file is associated with only one extent, then the file fragment indicator is set to a first value to indicate no fragmentation. However, if the corresponding file is associated with multiple extents, then the file fragment indicator is set to a different value to indicate fragmentation. In a non-extent based storage subsystem, the file fragment indicator can be set to different values based on some other technique of detecting whether a file is stored in a contiguous region of the storage medium of the storage subsystem 122, or in non-contiguous regions on the storage medium.

In the example implementation depicted in FIG. 1, the files 128 are stored in multiple clusters 130. A “cluster” refers to a group or any collection of files. Multiple clusters correspond to multiple groups or collections of files. Each cluster 130 is associated with a corresponding tag page 124, which contains multiple entries 125 for respective files that belong to the cluster. For example, if a cluster 130 has 512 user data files, then each tag page 124 will have 512 entries 125 corresponding to the 512 user data files. In other embodiments, a cluster-based file system is not implemented.

Although the storage subsystem 122 is depicted as being part of the host system 100, it is noted that the storage subsystem 122 can be implemented on a separate system than the host system 100. In either case, the host system 100 includes file system logic 106 that accesses data stored in the storage subsystem 122 through a device driver 107. The file system logic 106 receives requests (read or write requests) from software 109, such as application software or other types of software. In response to these requests, the file system logic 106 issues file system requests (read requests or write requests) to the storage subsystem 122 through the device driver 107 for reading or writing data in the storage subsystem 122.

The file system logic 106 and file system metadata (in the form of file attribute sections 126 and tag pages 124 according to one embodiment) are part of a file system. A file system is basically an entity that contains methods and routines, as well as data structures in the form of file system metadata, to organize user data (contained in the files 128) and to manage access of such user data. The files 128 themselves can also be considered to be part of the file system.

The host system 100 also contains a central processing unit (CPU) 102 (or multiple CPUs) that is coupled to a memory 104. The memory 104, according to one embodiment, is implemented with non-persistent storage device(s), such as a dynamic random access memory (DRAM), a synchronous DRAM (SDRAM), a static random access memory (SRAM), and so forth. On the other hand, the storage subsystem 122 is implemented with persistent storage devices, such as magnetic or optical disks, persistent integrated circuit storage devices, nanotechnology or microscopy-based storage devices, and so forth. In other embodiments, the memory 104 can be implemented as a persistent storage device.

The memory 104 is more closely coupled to the CPU 102 and has faster access speeds than the storage subsystem 122. The memory 104, according to some embodiments of the invention, contains a memory array structure 108 and a message queue 110, both used for purposes of performing defragmentation. The memory array structure 108 contains multiple entries, each containing a cluster fragment indicator (CFI) 116. The cluster fragment indicator 116 indicates whether a respective cluster 130 contains at least one fragmented file. Each entry of the memory array structure 108 corresponds to a tag page 124. In one implementation, the memory array structure 108 is a simple bitmap having entries that map to respective tag pages 124. Thus, as depicted in FIG. 1, the memory array structure 108 contains multiple entries for indicating whether respective multiple clusters contain fragmented files. Thus, a first entry in the memory array structure 108 indicates whether a first cluster 130 contains at least one fragmented file; a second entry in the memory array structure 108 indicates whether a second cluster 130 contains a fragmented file, and so forth.

Since the memory array structure 108 is stored in the memory 104 that has a faster access speed than the storage subsystem 122, the memory array structure 108 can be quickly accessed to determine if any cluster contains a fragmented file. In this way, the file system logic 106 does not have to waste time examining file system metadata (stored on the slower storage subsystem 122) associated with clusters that do not contain any fragmented files.

The cluster fragment indicators 116 are used by a “lightweight” defragment utility 114 that is part of the file system logic 106. In a different embodiment, the defragment utility 114 can be located outside the file system logic 106. The term “lightweight” indicates that the defragment utility 114 can be executed in the background while the file system remains mounted or otherwise available for access by software 109 in the host system 100 (or by an external device located externally to the host system 100). In other words, the lightweight defragment utility 114 can manage defragmentation of files in the storage subsystem 122 without unmounting (or taking offline) the file system. A file system being online or available means that software or other components can continue to access user files 128 by using information in the file system even while the defragment tasks are being performed.

The defragment utility 114 performs two general tasks. A first general task involves the update of the cluster fragment indicators 116 in the memory array structure 108 based on file fragment indicators in the tag pages 124 for respective files 128. As a file becomes fragmented, the file fragment indicator (contained in a tag page entry 125) for the file is set, which is reported to the defragment utility 114. The defragment utility 114 then sets the corresponding cluster fragment indicator 116 in the memory array structure 108.

The second general task performed by the defragment utility 114 is the examination of a cluster 130 indicated by a cluster fragment indicator 116 as containing at least one fragmented file 128. During a predetermined time slice, the defragment utility 114 examines one or more clusters indicated by the cluster fragment indicator 116 as containing fragmented files. The “predetermined time slice” refers to a period of time or time slice in the host system 100 that is allocated for performing defragment operations. Such time slices can be scheduled periodically, or can be scheduled on an as-available basis. The time slices are defined for performing defragmentation operations when the host system is not busy performing other tasks.

During such a predetermined time slice, the defragment utility 114 examines a cluster (associated with a set cluster fragment indicator 116) to find specific file(s) 128 that is (are) fragmented, based on the examination of the file fragment indicators in respective tag page entries 125. For each file 128 where a respective file fragment indicator is set to indicate that the file is fragmented, a message is provided to the message queue 110. The message is stored as a message entry 120 in the message queue 110, which contains information relating to the fragmented file.

The message entries 120 in the message queues 110 are used by the defragment utility 114 to invoke defragment kernel threads 112, which use the message queue information to perform defragmentation of respective files 128. The defragment kernel threads 112 are associated with the kernel of an operating system (not known) in the host system 100. In other embodiments, instead of being kernel threads, the defragment logic can be implemented in other types of defragment software modules.

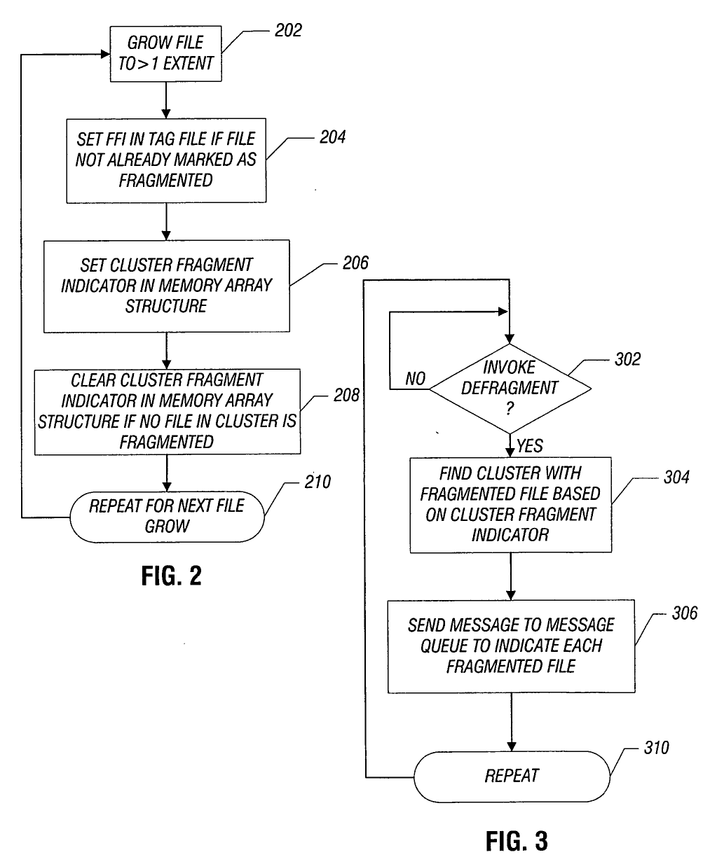

FIG. 2 illustrates a process of maintaining the file fragment indicator in a tag page 124 and the cluster fragment indicator in the memory array structure 108. Reference is made to FIGS. 1 and 2 in the following description. In response to detecting that a file 128 has grown in size (at 202) to greater than one extent, the file system logic 106 sets (at 204) the file fragment indicator in the corresponding tag page entry 125 (if the file fragment indicator is not already set).

According to some implementations, some tag page entries 125 are stored in a cache in the memory 104 (for quicker access). In such implementations, any update of file fragment indicator in a tag page entry 125 (on the storage medium of the storage subsystem 122) also updates the file fragment indicator of any copy of the tag page entry 125 in the memory 104. A file 128 growing in size to greater than one extent is an indication that the file is fragmented. In other implementations, other techniques for detecting fragmentation of a file (file is located in dis-contiguous regions on the storage medium) can be used.

In response to the setting of a file fragment indicator, the defragment utility 114 also sets (at 206) a cluster fragment indicator 116 in the memory array structure 108 for the corresponding cluster (that contains the fragmented file). However, if no file in the cluster is fragmented (based on detecting that all file fragment indicators for files in the cluster have the cleared state), then the cluster fragment indicator 116 in the memory array structure 108 corresponding to the cluster is cleared (at 208).

The process of 202-208 is repeated (at 210) in response to the next file growing to greater than one extent where the extents are dis-contiguous.

Instead of waiting for detection of a file growing in size to greater than one extent to perform acts 204, 206, and 208, it is noted that the file system logic 106 can schedule (periodically or otherwise) examinations to determine whether cluster fragment indicators in the memory array structure 108 or file fragment indicators in the tag page entries 125 should be set or cleared.

FIG. 3 shows a flow diagram of initiating the defragmentation of files in a cluster. Reference is made to FIGS. 1 and 3 in the following discussion. The defragment utility 114 determines (at 302) if defragmentation is to be invoked for a particular cluster. In one implementation, the decision to invoke defragmentation is based on whether the host system has entered a time slice reserved for performing defragmentation. Alternatively, some other event in the host system can cause a decision to invoke defragmentation.

If defragmentation is to proceed, the defragment utility 114 finds (at 304) a cluster with fragmented files based on the cluster fragment indicator 116 for the cluster. By examining clusters associated with cluster fragment indicators 116 that are set, the defragment utility 114 does not have to waste time examining clusters that do not contain any fragmented files. Also note that the cluster fragment indicators 116 are stored in the memory 104 with faster access speeds. As a result, the cluster fragment indicators 116 can be accessed much more quickly than the file fragment indicators stored in the storage subsystem 122.

In examining a cluster 130 associated with a set cluster fragment indicator 116, the defragment utility 114 finds files 128 that are fragmented based on reading the file fragment indicators in respective tag page entries 125. For each fragmented file, the defragment utility 114 sends (at 306) a message to the message queue 110 for storing information in a message entry 120 associated with the fragmented file.

The process of FIG. 3 is repeated (at 310) for other fragmented files or other clusters.

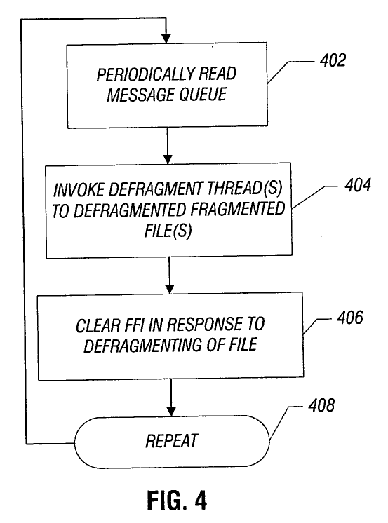

With reference to FIGS. 1 and 4, the defragment utility 114 periodically reads (at 402) the message queue 110, which contains information pertaining to fragmented files. For each entry 120 of the message queue 110, the defragment utility 114 invokes (at 404) defragment kernel threads 112 (or other types of defragment modules) to perform defragmentation of the fragmented files identified in the message queue entry. In response to defragmenting a file, the corresponding file fragment indicator in the corresponding tag page entry 125 is cleared (at 406). If a copy of the tag page entry 125 is also present in the memory 104, the file fragment indicator of the copy of the tag page entry 125 is also cleared.

Note that the cluster fragment indicator 116 in the memory array structure 108 is not cleared until all files in the cluster are defragmented.

The process of FIG. 4 is repeated (at 408) for other message queue entries.

Note that the file system remains mounted (online or available) while the defragment utility 114 and defragment kernel threads 112 perform their respective tasks. Also, the defragment kernel threads 112 can be invoked or not based on system availability. Thus, during periods of high system use, invocation of the defragment kernel threads 112 can be throttled or turned off.

The defragment mechanism according to some embodiments (including, for example, the defragment utility 114, defragment kernel threads 112, in-memory memory array structure 108, and file fragment indicators stored as file system metadata) is a relatively efficient mechanism that uses an in-memory data structure (108) to quickly ascertain clusters 130 that contain fragmented file(s). Also, the defragment mechanism can be an automated mechanism that does not involve human system administrator intervention. The defragment mechanism can also control its level of activity (such as not performing certain tasks during periods of high system activity) to avoid over-loading the system. Also, the defragment mechanism can perform its tasks while the file system remains online and the files 128 remain available for access.

The flow diagrams of FIGS. 2-4 are exemplary, where the acts/blocks of the figure can be added, removed, altered, and so forth, and still be covered by embodiments of the invention.

Instructions of software routines (including the file system logic 106, defragment utility 114, defragment kernel threads 112, and software 109 in FIG. 1) are loaded for execution on a processor (e.g., CPU 102). The processor includes microprocessors, microcontrollers, processor modules or subsystems (including one or more microprocessors or microcontrollers), or other control or computing devices.

Data and instructions (of the software) are stored in respective storage devices, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A system comprising:
software;
a storage subsystem to store files;
a file system to organize and manage access of the files;
a data structure to store at least one indicator of whether at least one of the files is fragmented; and
a defragment module to defragment the at least one of the files based on the at least one indicator while the file system remains available to the software.

2. The system of claim 1, further comprising memory to store the data structure, wherein the memory has a faster access speed than the storage subsystem.

3. The system of claim 1, wherein the at least one file is part of a group of files, and wherein the indicator in the data structure indicates whether the group contains at least one fragmented file.

4. The system of claim 3, wherein the data structure contains additional indicators to indicate whether respective additional groups of files contain fragmented files, and wherein the defragment module defragments fragmented files in the additional groups based on the additional indicators while the file system remains available to the software.

5. The system of claim 1, wherein the storage subsystem further contains file system metadata, the file system metadata containing attributes to indicate whether respective files are fragmented, the attributes of the file system metadata being separate from the at least one indicator.

6. The system of claim 1, wherein the file system comprises file system logic to detect a state of the at least one indicator, the file system logic to invoke the defragment module to defragment the at least one of the files based on the at least one indicator.

7. The system of claim 1, wherein the at least one file is part of a group of files, and the at least one indicator indicates whether the group contains at least one fragmented file, wherein the file system comprises file system logic to examine the group based on the at least one indicator having a value to indicate that the group contains at least one fragmented file, and in response to finding at least one file in the group that is fragmented, the file system logic to invoke the defragment module.

8. The system of claim 1, further comprising a memory, wherein the at least one indicator is contained in the memory, and wherein the file system further contains file system metadata associated with respective files, the file system metadata containing attributes to indicate whether respective files are fragmented, the file system logic to examine the attributes of respective files to determine whether the respective files are fragmented.

9. The system of claim 8, wherein the attributes contain file fragment indicators to indicate whether respective files are fragmented, and wherein each file fragment indicator is set to a state to indicate a corresponding file is fragmented in response to detecting that the corresponding file is stored in plural non-contiguous extents.

10. The system of claim 9, wherein the attributes further contain extent attributes to indicate a number of extents associated with each file.

11. A method comprising:
storing, in a data structure, an indicator of whether a group of files contains one or more files that are fragmented;
storing attributes associated with respective files to indicate whether the respective files are fragmented, the attributes being separate from the data structure;
updating the indicator based on the attributes; and
examining the group of files based on the indicator to perform defragmentation with respect to the one or more files in the group that are fragmented.

12. The method of claim 11, wherein storing the data structure comprises storing the data structure in non-persistent memory, and wherein storing the attributes comprises storing the attributes in persistent storage.

13. The method of claim 11, further comprising storing additional indicators in the data structure, the additional indicators associated with respective additional groups of files, the additional indicators to indicate whether respective additional groups contain one or more files that are fragmented.

14. The method of claim 13, wherein each indicator has a first value to indicate that the corresponding group contains at least one fragmented file, and a second value to indicate that the corresponding group does not contain any fragmented file, the method further comprising examining groups associated with indicators having the first value to find fragmented files, but not examining groups associated with indicators having the second value.

15. The method of claim 11, wherein storing the attributes comprises storing a field to indicate fragmentation in a respective tag page entry associated with each respective file.

16. The method of claim 15, wherein storing the indicator in the data structure comprises storing the indicator in a bitmap.

17. The method of claim 11, wherein the files and attributes are part of a file system, the method further comprising defragmenting one or more files in the group while the file system remains available for access by software.

18. An article comprising at least one storage medium containing instructions that when executed cause a system to:
store files in plural clusters in a storage subsystem;
store file system metadata for respective files, wherein the file system metadata contains attributes for respective files to indicate whether the respective files are fragmented;
store indicators associated with respective clusters, the indicators to indicate whether respective clusters contain at least one fragmented file; and
perform defragment operations based on the indicators and the attributes.

19. The article of claim 18, wherein storing the file system metadata comprises storing the file system metadata in the storage subsystem, and wherein storing the indicators comprises storing the indicators in a memory separate from the storage subsystem.

20. The article of claim 18, wherein the instructions when executed cause the system to further:
examine the indicators to identify a cluster containing one or more fragmented files;
examine the identified cluster to find one or more files that are fragmented based on the attributes for files in the identified cluster;
in response to finding one or more fragmented files, performing defragmentation of the one or more fragmented files.

21. The article of claim 20, wherein the instructions when executed cause a system to further:
for each of the one or more fragmented files in the identified cluster, send information to a queue; and
invoke one or more defragment modules to defragment the one or more fragmented files based on the information in the queue.

22. The article of claim 21, wherein the one or more defragment modules comprise one or more defragment kernel threads.

23. The article of claim 18, wherein the instructions when executed cause the system to:
clear any indicator associated with a cluster that does not contain any fragmented file.

24. A system comprising:
a storage subsystem having a persistent storage to store files and file system metadata for respective files, wherein the file system metadata contains attributes for respective files to indicate whether the respective files are fragmented, the files being divided into plural groups;
a non-persistent memory to store indicators associated with respective clusters, the indicators to indicate whether respective clusters contain at least one fragmented file;
at least one defragment module; and
a defragment utility to:
examine the indicators to identify a corresponding cluster containing at least one fragmented file,
find, based on the attributes for the files in the identified cluster, at least one fragmented file in the identified cluster, and
invoke the at least one defragment module to defragment the at least one fragmented file.

25. The system of claim 24, wherein the attributes are stored in tag pages, each tag page corresponding to a respective group, and each tag page having plural entries corresponding to plural files in the group.
